(19) United States
(12) Patent Application Publication
(10) Pub. No.: US 2026/0216842 A1
(43) Pub. Date: Jul. 30, 2026

(54) POLISHING APPARATUS AND POLISHING METHOD

(71) Applicant: EBARA CORPORATION, Tokyo (JP)

(72) Inventor: Masaki KINOSHITA, Tokyo (JP)

(21) Appl. No.: 19/456,591

(22) Filed: Jan. 22, 2026

(30) Foreign Application Priority Data
Jan. 24, 2025 (JP) 2025-010669

(51) Int. Cl. B24B 37/013

(52) U.S. Cl. CPC B24B 37/013

(57) ABSTRACT

A polishing apparatus capable of accurately determining a position of a measurement point of a film thickness of a workpiece is disclosed. The polishing apparatus includes: a polishing head configured to press a workpiece against a polishing pad on a polishing table to polish the workpiece; a film-thickness sensor configured to measure a film thickness at a measurement point on a surface of the workpiece; an infrared imaging device configured to generate a first image and a second image of a feature region on the surface of the workpiece at a predetermined time interval through a back surface of the workpiece; and a processing controller configured to determine coordinates of the measurement point on the surface of the workpiece based on the first image and the second image.

### CROSS REFERENCE TO RELATED APPLICATION

This document claims priority to Japanese Patent Application No. 2025-010669 filed January 24, 2025, the entire contents of which are hereby incorporated by reference.

### BACKGROUND

In chemical mechanical polishing (CMP), a surface of a workpiece (e.g., a wafer) is polished by pressing the workpiece against a polishing pad placed on a rotating polishing table while the workpiece is rotated. During polishing of the workpiece, a polishing liquid (e.g., slurry) is supplied onto the polishing pad.

A film-thickness sensor is disposed in the polishing table to measure a film thickness of the workpiece. The film-thickness sensor is configured to measure the film thickness while traversing the workpiece during polishing of the workpiece. Examples of the film-thickness sensor include an optical sensor and an eddy-current sensor. The film-thickness sensor moves in a different path each time the film-thickness sensor traverses the workpiece to measure film thicknesses at multiple measurement points. Therefore, the measurement points are distributed through an entire surface of the workpiece.

The film thickness of the workpiece may vary not only in a radial direction but also in a circumferential direction of the workpiece. In order to polish the workpiece so as to reduce the variation in film thickness in the circumferential direction of the workpiece, it is necessary to measure the variation in film thickness in the circumferential direction during polishing of the workpiece.

However, during polishing of the workpiece, the workpiece may not rotate together with the polishing head, so that the workpiece may rotate relative to the polishing head in the polishing head. Therefore, a rotation speed of the workpiece may not be the same as that of the polishing head. As a result, positions of the measurement points in the circumferential direction of the workpiece may not be specified, and there has been a problem that the film thicknesses in the circumferential direction of the workpiece may not be measured accurately.

### SUMMARY

Therefore, there are provided a polishing apparatus and a polishing method capable of accurately determining a position of a measurement point of a film thickness of a workpiece.

Embodiments, which will be described below, relate to a technique of polishing a workpiece, such as a wafer, a substrate, or a panel, while measuring a film thickness of the workpiece, and more particularly to a technique of specifying a measurement point of the film thickness.

In an embodiment, there is provided a polishing apparatus comprising: a polishing table configured to support a polishing pad; a polishing head configured to press a workpiece against the polishing pad on the polishing table to polish the workpiece, the workpiece having a surface on which a feature region is formed; a polishing-head motor configured to rotate the polishing head; a film-thickness sensor fixed to the polishing table and configured to measure a film thickness at a measurement point on the surface of the workpiece; an infrared imaging device arranged in the polishing head and configured to generate a first image and a second image of the feature region on the surface of the workpiece at a predetermined time interval through a back surface of the workpiece; and a processing controller configured to determine coordinates of the measurement point on the surface of the workpiece based on the first image and the second image.

In an embodiment, a processing controller is configured to: calculate a rotation angle of the workpiece per unit time based on an angle of inclination of the feature region on the first image, an angle of inclination of the feature region on the second image, and the predetermined time interval; calculate a time difference between a measuring time when the film thickness at the measurement point is measured and an imaging time when the second image is generated; and determine the coordinates of the measurement point on the surface of the workpiece based on a relative position of the measurement point and a center point of the workpiece, the rotation angle of the workpiece per unit time, and the time difference.

In an embodiment, the processing controller is configured to: determine an angle of inclination of a coordinate system predefined on the surface of the workpiece based on the angle of inclination of the feature region on the second image; calculate a rotation angle of the coordinate system that rotates during the time difference by multiplying the rotation angle of the workpiece per unit time by the time difference; determine the coordinate system at the measuring time by rotating the coordinate system at the imaging time by the calculated rotation angle about the center point of the workpiece; and determine the coordinates of the measurement point on the coordinate system at the measuring time from the relative position of the measurement point and the center point of the workpiece.

In an embodiment, the polishing apparatus further comprises: an infrared light source arranged in the polishing head and configured to irradiate the feature region on the surface of the workpiece with infrared light through the back surface of the workpiece, wherein the infrared light has a wavelength that allows the infrared light to pass through the workpiece and reflect off the feature region, and the infrared imaging device is configured to generate the first image and the second image by receiving the infrared light that is emitted from the infrared light source and is reflected from the feature region.

In an embodiment, the polishing head includes: an elastic membrane for pressing the workpiece against the polishing pad; and a carrier to which the elastic membrane is fixed, the infrared imaging device and the infrared light source are fixed to the carrier, and the infrared light has a wavelength that allows the infrared light to pass through the elastic membrane and the workpiece and reflect off the feature region.

In an embodiment, the polishing apparatus further comprises: a half-mirror arranged in the polishing head and configured to allow the infrared light emitted from the infrared light source to pass therethrough and reflect the infrared light reflected from the feature region, wherein the half-mirror is obliquely arranged on an optical path of the infrared light emitted from the infrared light source and an optical path of the infrared light reflected from the feature region, and the infrared imaging device is configured to generate the first image and the second image by receiving the infrared light that is emitted from the infrared light source, passes through the half-mirror, is reflected from the feature region, and is reflected from the half-mirror.

In an embodiment, the polishing apparatus further comprises: a half-mirror arranged in the polishing head and configured to reflect the infrared light emitted from the infrared light source and allow the infrared light reflected from the feature region to pass therethrough, wherein the half-mirror is obliquely arranged on an optical path of the infrared light emitted from the infrared light source and an optical path of the infrared light reflected from the feature region, and the infrared imaging device is configured to generate the first image and the second image by receiving the infrared light that is emitted from the infrared light source, is reflected from the half-mirror, is reflected from the feature region, and passes through the half-mirror.

In an embodiment, the polishing apparatus further comprises: a head-angle detector configured to detect a rotation angle of the polishing head, wherein the infrared imaging device is fixed to the polishing head, the processing controller is configured to: calculate a difference in angle of inclination of the feature region between the first image and the second image; calculate a relative rotation angle of the workpiece with respect to the polishing head per unit time by dividing the difference in angle of inclination by the predetermined time interval; and calculate the rotation angle of the workpiece per unit time by subtracting the relative rotation angle of the workpiece with respect to the polishing head per unit time from a rotation angle of the polishing head in the predetermined time interval detected by the head-angle detector.

In an embodiment, the polishing apparatus further comprises: a fixing member configured to fix the infrared imaging device, wherein the infrared imaging device is not in contact with the polishing head and does not rotate together with the polishing head, and the processing controller is configured to: calculate a difference in angle of inclination of the feature region between the first image and the second image; and calculate the rotation angle of the workpiece per unit time by dividing the difference in angle of inclination by the predetermined time interval.

In an embodiment, the polishing head includes: an elastic membrane for pressing the workpiece against the polishing pad; and a carrier to which the elastic membrane is fixed, the elastic membrane has a mark for specifying an orientation in a circumferential direction of the elastic membrane, the infrared imaging device is fixed to the carrier, and the processing controller is configured to: calculate the angle of inclination of the feature region on the first image based on the mark on the first image; calculate the angle of inclination of the feature region on the second image based on the mark on the second image; and calculate the rotation angle of the workpiece per unit time based on the predetermined time interval.

In an embodiment, there is provided a polishing method comprising: polishing a workpiece by pressing the workpiece against a polishing pad on a polishing table with a polishing head while rotating the polishing head, the workpiece having a surface on which a feature region is formed; during polishing of the workpiece, generating a first image and a second image of the feature region on the surface of the workpiece at a predetermined time interval through a back surface of the workpiece by an infrared imaging device arranged in the polishing head; during polishing of the workpiece, measuring a film thickness at a measurement point on the surface of the workpiece by a film-thickness sensor fixed to the polishing table; and determining coordinates of the measurement point on the surface of the workpiece based on the first image and the second image.

In an embodiment, determining the coordinates of the measurement point comprises: calculating a rotation angle of the workpiece per unit time based on an angle of inclination of the feature region on the first image, an angle of inclination of the feature region on the second image, and the predetermined time interval; calculating a time difference between a measuring time when the film thickness at the measurement point is measured and an imaging time when the second image is generated; and determining the coordinates of the measurement point on the surface of the workpiece based on a relative position of the measurement point and a center point of the workpiece, the rotation angle of the workpiece per unit time, and the time difference.

In an embodiment, determining the coordinates of the measurement point on the surface of the workpiece based on the relative position of the measurement point and the center point of the workpiece, the rotation angle of the workpiece per unit time, and the time difference comprises: determining an angle of inclination of a coordinate system predefined on the surface of the workpiece based on the angle of inclination of the feature region on the second image; calculating a rotation angle of the coordinate system that rotates during the time difference by multiplying the rotation angle of the workpiece per unit time by the time difference; determining the coordinate system at the measuring time by rotating the coordinate system at the imaging time by the calculated rotation angle about the center point of the workpiece; and determining the coordinates of the measurement point on the coordinate system at the measuring time from the relative position of the measurement point and the center point of the workpiece.

In an embodiment, the polishing method further comprises: during polishing of the workpiece, irradiating the feature region on the surface of the workpiece with infrared light through the back surface of the workpiece by an infrared light source arranged in the polishing head, wherein generating the first image and the second image by the infrared imaging device comprises generating the first image and the second image by receiving the infrared light that is emitted from the infrared light source and is reflected from the feature region, and the infrared light has a wavelength that allows the infrared light to pass through the workpiece and reflect off the feature region.

In an embodiment, the polishing head includes: an elastic membrane for pressing the workpiece against the polishing pad; and a carrier to which the elastic membrane is fixed, the infrared imaging device and the infrared light source are fixed to the carrier, and the infrared light has a wavelength that allows the infrared light to pass through the elastic membrane and the workpiece and reflect off the feature region.

In an embodiment, generating the first image and the second image by the infrared imaging device comprises generating the first image and the second image by receiving the infrared light with the infrared imaging device, the infrared light being emitted from the infrared light source, passing through a half-mirror arranged in the polishing head, being reflected from the feature region, and being reflected from the half-mirror, and the half-mirror is obliquely arranged on an optical path of the infrared light emitted from the infrared light source and an optical path of the infrared light reflected from the feature region.

In an embodiment, generating the first image and the second image by the infrared imaging device comprises generating the first image and the second image by receiving the infrared light with the infrared imaging device, the infrared light being emitted from the infrared light source, being reflected from a half-mirror arranged in the polishing head, being reflected from the feature region, and passing through the half-mirror, and the half-mirror is obliquely arranged on an optical path of the infrared light emitted from the infrared light source and an optical path of the infrared light reflected from the feature region.

In an embodiment, the polishing method further comprises: detecting a rotation angle of the polishing head, wherein the infrared imaging device is fixed to the polishing head, and calculating the rotation angle of the workpiece per unit time comprises: calculating a difference in angle of inclination of the feature region between the first image and the second image; calculating a relative rotation angle of the workpiece with respect to the polishing head per unit time by dividing the difference in angle of inclination by the predetermined time interval; and calculating the rotation angle of the workpiece per unit time by subtracting the relative rotation angle of the workpiece with respect to the polishing head per unit time from a rotation angle of the polishing head in the predetermined time interval detected by a head-angle detector.

In an embodiment, the infrared imaging device is fixed to a fixing member, is not in contact with the polishing head, and does not rotate together with the polishing head, and calculating the rotation angle of the workpiece per unit time comprises: calculating a difference in angle of inclination of the feature region between the first image and the second image; and calculating the rotation angle of the workpiece per unit time by dividing the difference in angle of inclination by the predetermined time interval.

In an embodiment, the polishing head includes: an elastic membrane for pressing the workpiece against the polishing pad; and a carrier to which the elastic membrane is fixed, the elastic membrane has a mark for specifying an orientation in a circumferential direction of the elastic membrane, the infrared imaging device is fixed to the carrier, and calculating the rotation angle of the workpiece per unit time comprises: calculating the angle of inclination of the feature region on the first image based on the mark on the first image; calculating the angle of inclination of the feature region on the second image based on the mark on the second image; and calculating the rotation angle of the workpiece per unit time based on the predetermined time interval.

The rotation angle of the workpiece per unit time can be calculated from the first image and the second image of the feature region on the surface of the workpiece. The coordinates of the measurement point of the film thickness of the workpiece can be determined based on this rotation angle per unit time.

### BRIEF DESCRIPTION OF THE DRAWINGS

FIG. 1 is a schematic diagram showing an embodiment of a polishing apparatus;

FIG. 2 is a cross-sectional view showing an embodiment of a polishing head;

FIG. 3 is a schematic diagram showing a manner in which an infrared imaging device generates an image of feature region formed in a workpiece;

FIG. 4 is a top view showing a positional relationship between a polishing table and the workpiece held by the polishing head;

FIG. 5 is a schematic diagram showing an example of generating a first image and a second image by the imaging device;

FIG. 6 is a schematic diagram showing an example of the first image and the second image generated by the infrared imaging device;

FIG. 7 is a schematic diagram showing an example of a coordinate system defined on a surface of the workpiece;

FIG. 8 is a schematic diagram showing another example of the feature region;

FIG. 9 is a schematic diagram showing an example of the first image and the second image including the feature region shown in FIG. 8;

FIG. 10 is a schematic diagram showing an example of generating the images by the imaging device and measuring a film thickness by a film-thickness sensor;

FIG. 11 is a schematic diagram showing another example of generating the image by the imaging device and measuring the film thickness by the film-thickness sensor;

FIG. 12 is a top view showing another embodiment of the film-thickness sensor;

FIG. 13 is a cross-sectional view of a polishing head provided with another embodiment of the infrared imaging device and an infrared light source;

FIG. 14 is a top view showing a positional relationship between the polishing table and the workpiece held by the polishing head according to the embodiment shown in FIG. 13;

FIG. 15 is a cross-sectional view of the polishing head provided with still another embodiment of the infrared imaging device and the infrared light source;

FIG. 16 is a cross-sectional view of the polishing head provided with still another embodiment of the infrared imaging device and the infrared light source;

FIG. 17 is a cross-sectional view of the polishing head provided with still another embodiment of the infrared imaging device and the infrared light source;

FIG. 18 is a cross-sectional view of the polishing head provided with still another embodiment of the infrared imaging device and the infrared light source;

FIG. 19 is a schematic diagram showing an embodiment of an elastic membrane having a mark;

FIG. 20 is a schematic diagram showing an example of the first image generated by the infrared imaging device arranged in the polishing head having the elastic membrane shown in FIG. 19; and

FIG. 21 is a cross-sectional view of the polishing head provided with an embodiment of the infrared imaging device not fixed to the polishing head.

### DESCRIPTION OF EMBODIMENTS

### Embodiments will now be described with reference to the drawings.

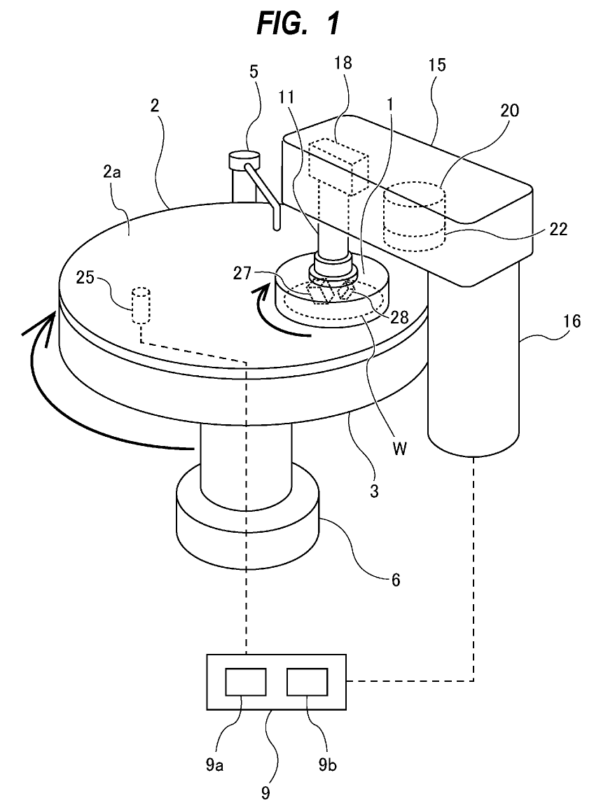

FIG. 1 is a schematic diagram showing an embodiment of a polishing apparatus. As shown in FIG. 1, the polishing apparatus includes a polishing table 3 configured to support a polishing pad 2, a polishing head 1 configured to press a workpiece W against the polishing pad 2, a table motor 6 configured to rotate the polishing table 3, and a polishing-liquid supply nozzle 5 configured to supply a polishing liquid (e.g., a slurry containing abrasive particles) onto the polishing pad 2. The polishing pad 2 has a surface constituting a polishing surface 2a for polishing the workpiece W.

Specific examples of the workpiece W include a wafer, an interconnect substrate, a quadrangular substrate, etc., for use in manufacturing of semiconductor devices. The workpiece W has a surface on which feature region(s) is formed. Specific examples of the feature region(s) include pattern(s), such as cell(s) forming interconnect(s) or scribing line(s) (i.e., dicing line(s)), and region(s) distinguishable from other region(s) due to a difference in film thickness, material, etc.

The polishing table 3 is coupled to the table motor 6, and the table motor 6 is configured to rotate the polishing table 3 together with the polishing pad 2. The polishing head 1 is fixed to an end of a polishing-head shaft 11, and the polishing-head shaft 11 is rotatably supported by a head arm 15. The head arm 15 is rotatably supported by a support shaft 16.

The polishing-head shaft 11 is coupled to a polishing-head vertically moving mechanism 18 disposed in the head arm 15. The polishing-head vertically moving mechanism 18 is configured to vertically move the polishing-head shaft 11 along its own axis. The vertical movement of the polishing-head shaft 11 by the polishing-head vertically moving mechanism 18 enables the workpiece W held by the polishing head 1 to move closer to and away from the polishing pad 2 on the polishing table 3. The configuration of the polishing-head vertically moving mechanism 18 is not particularly limited. In an example, the polishing-head vertically moving mechanism 18 includes a servo motor, a ball screw mechanism, etc.

The polishing-head shaft 11 is coupled to a polishing-head motor 20 disposed in the head arm 15. The polishing-head motor 20 is configured to rotate the polishing-head shaft 11 and the polishing head 1 about their respective axes. The configuration of the polishing-head motor 20 is not particularly limited. In an example, the polishing-head motor 20 includes an electric motor, a belt, pulleys, etc.

The polishing apparatus further includes a processing controller 9 configured to control operations of each component of the polishing apparatus. The processing controller 9 is electrically coupled to the polishing head 1, the table motor 6, the polishing-liquid supply nozzle 5, the polishing-head vertically moving mechanism 18, and the polishing-head motor 20. The processing controller 9 controls operations of the polishing head 1, the table motor 6, the polishing-liquid supply nozzle 5, the polishing-head vertically moving mechanism 18, and the polishing-head motor 20.

The processing controller 9 includes a memory 9a storing programs therein, and an arithmetic device 9b configured to perform arithmetic operations according to instructions contained in the programs. The processing controller 9 is composed of at least one computer. The memory 9a includes a main memory, such as a random-access memory (RAM), and an auxiliary memory, such as a hard disk drive (HDD) or a solid state drive (SSD). Examples of the arithmetic device 9b include a CPU (central processing unit) and a GPU (graphics processing unit). However, the specific configuration of the processing controller 9 is not limited to these examples. The processing controller 9 may also be composed of multiple computers.

Polishing of the workpiece W is performed as follows. The processing controller 9 instructs the table motor 6, the polishing-head motor 20, and the polishing-liquid supply nozzle 5 to rotate the polishing table 3 and the polishing head 1 in directions indicated by arrows in FIG. 1, while supplying the polishing liquid onto the polishing surface 2a of the polishing pad 2 on the polishing table 3 from the polishing-liquid supply nozzle 5. The workpiece W is pressed against the polishing surface 2a of the polishing pad 2 by the polishing head 1 in the presence of the polishing liquid between the polishing pad 2 and the workpiece W, while the workpiece W is being rotated by the polishing head 1. The surface of the workpiece W is polished by a chemical action of the polishing liquid and mechanical action(s) of abrasive grains contained in the polishing liquid and/or the polishing pad 2.

The polishing apparatus further includes a film-thickness sensor 25 configured to measure a film thickness of the workpiece W on the polishing pad 2. The film-thickness sensor 25 is fixed to the polishing table 3 and rotates together with the polishing table 3. The film-thickness sensor 25 is configured to measure the film thickness at a measurement point on the surface of the workpiece W each time the film-thickness sensor 25 traverses the surface of the workpiece W. Specific examples of the film-thickness sensor 25 include an optical film-thickness sensor and an eddy-current film-thickness sensor. The type of the film-thickness sensor 25 is not particularly limited as long as the film-thickness sensor 25 can measure the film thickness of the workpiece W. The film-thickness sensor 25 is electrically coupled to the processing controller 9, and measurement values of the film thickness are transmitted from the film-thickness sensor 25 to the processing controller 9.

The polishing apparatus further includes a head-angle detector (e.g., a rotary encoder) 22 configured to detect a rotation angle of the polishing head 1. The head-angle detector 22 is configured to detect a rotation angle of the polishing-head motor 20. The rotation angle of the polishing-head motor 20 is proportional to the rotation angle of the polishing head 1. In one embodiment, the rotation angle of the polishing-head motor 20 coincides with the rotation angle of the polishing head 1. Therefore, the rotation angle of the polishing-head motor 20 detected by the head-angle detector 22 corresponds to the rotation angle of the polishing head 1. The head-angle detector 22 is electrically coupled to the processing controller 9. Detected values of the rotation angle of the polishing-head motor 20 (i.e., detected values of the rotation angle of the polishing head 1) output from the head-angle detector 22 are transmitted to the processing controller 9.

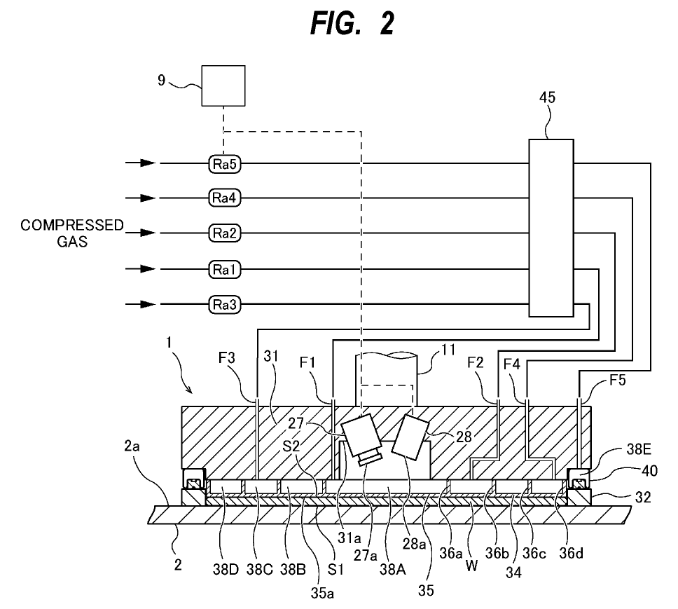

FIG. 2 is a cross-sectional view showing an embodiment of the polishing head 1. The polishing head 1 includes a carrier 31 fixed to the end of the polishing-head shaft 11, an elastic membrane 34 attached to a lower portion of the carrier 31, and a retainer ring 32 arranged below the carrier 31. The retainer ring 32 is arranged around the elastic membrane 34. The retainer ring 32 is an annular structure configured to retain the workpiece W so as to prevent the workpiece W from being ejected from the polishing head 1 during polishing of the workpiece W.

The elastic membrane 34 includes a contact portion 35 having a contact surface 35a which is contactable with an upper surface of the workpiece W, and inner wall portions 36a, 36b, 36c and an outer wall portion 36d coupled to the contact portion 35. The contact portion 35 has substantially the same size and the same shape as those of the upper surface of the workpiece W. The inner wall portions 36a, 36b, and 36c and the outer wall portion 36d are endless walls concentrically arranged.

A plurality of pressure chambers (in this embodiment, four pressure chambers) 38A, 38B, 38C, and 38D are provided between the elastic membrane 34 and the carrier 31. The pressure chambers 38A, 38B, 38C, and 38D are formed by the contact portion 35, the inner wall portions 36a, 36b, and 36c, and the outer wall portion 36d of the elastic membrane 34. In this embodiment, the elastic membrane 34 forms four pressure chambers 38A to 38D, while in one embodiment, the elastic membrane 34 may form three pressure chambers, or five or more pressure chambers.

An annular membrane (rolling diaphragm) 40 is arranged between the carrier 31 and the retainer ring 32. A pressure chamber 38E is formed inside the membrane 40. Gas delivery lines F1, F2, F3, F4, and F5 are coupled to the pressure chambers 38A, 38B, 38C, 38D, and 38E, respectively. The gas delivery lines F1, F2, F3, F4, and F5 extend through a rotary joint 45 attached to the polishing-head shaft 11.

The gas delivery lines F1, F2, F3, F4, and F5 are coupled to a compressed-gas supply source (not shown) which is a utility supply source provided in a factory where the polishing apparatus is installed. Compressed gas, such as compressed air, is supplied to the pressure chambers 38A, 38B, 38C, 38D, and 38E through the gas delivery lines F1, F2, F3, F4, and F5, respectively.

Pressure regulators Ra1, Ra2, Ra3, Ra4, and Ra5 are coupled to the gas delivery lines F1, F2, F3, F4, and F5, respectively. The pressure regulators Ra1 to Ra5 can change the pressures in the pressure chambers 38A to 38E independently of each other. Therefore, the polishing head 1 can independently regulate polishing pressures on four corresponding regions of the workpiece W (i.e., a central portion, an inner intermediate portion, an outer intermediate portion, and an edge portion) and a pressing force of the retainer ring 32 against the polishing surface 2a of the polishing pad 2. For example, the polishing head 1 can press different regions of the surface (i.e., a front surface) S1 of the workpiece W against the polishing surface 2a of the polishing pad 2 with different pressing forces. Therefore, the polishing head 1 can control a film-thickness profile of the workpiece W to achieve a target film-thickness profile.

As shown in FIG. 2, the polishing apparatus further includes an infrared imaging device 27 configured to generate an image of the feature region(s) on the surface S1 of the workpiece W, and an infrared light source 28 configured to emit infrared light. The infrared imaging device 27 and the infrared light source 28 are arranged in the polishing head 1. The infrared imaging device 27 and the infrared light source 28 of this embodiment are fixed to the polishing head 1, and rotate together with the polishing head 1. In this embodiment, the infrared imaging device 27 is arranged at a center of the polishing head 1. The infrared imaging device 27 and the infrared light source 28 are fixed to the carrier 31, and are arranged above the elastic membrane 34. The carrier 31 has a recess 31a in which a light-receiving portion 27a of the infrared imaging device 27 and a light-emitting portion 28a of the infrared light source 28 are arranged. The recess 31a is open in a bottom surface of the carrier 31. In this embodiment, the recess 31a is located at the center of the polishing head 1 and communicates with the pressure chamber 38A. In one embodiment, the opening of the recess 31a may be covered by a transparent window (not shown) that transmits the infrared light.

The infrared imaging device 27 is configured to generate a plurality of images of the feature region on the surface S1 of the workpiece W at a predetermined time interval through a back surface S2 of the workpiece W. The infrared light source 28 is configured to irradiate the feature region on the surface S1 of the workpiece W with the infrared light through the back surface S2 of the workpiece W. The back surface S2 of the workpiece W is a surface opposite the surface S1 on which the feature region is formed. The infrared imaging device 27 is electrically coupled to the processing controller 9, and the images of the feature region are transmitted from the infrared imaging device 27 to the processing controller 9 shown in FIG. 1.

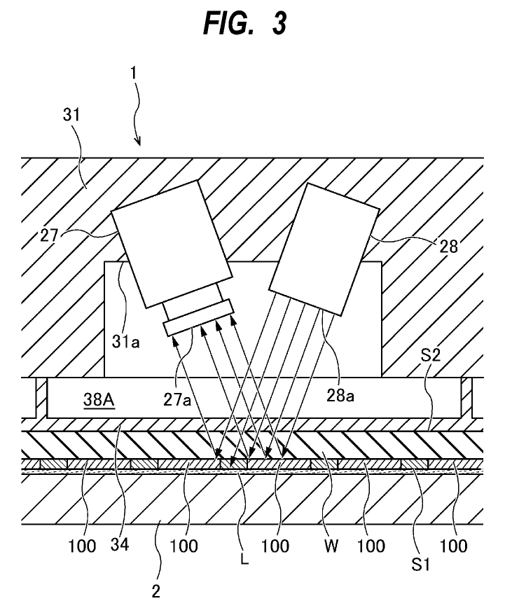

FIG. 3 is a schematic diagram showing a manner in which the infrared imaging device 27 generates image of feature region 100 of the workpiece W. The infrared light source 28 is disposed adjacent to the infrared imaging device 27. The infrared light source 28 is configured to emit the infrared light having a wavelength that allows the infrared light to pass through the elastic membrane 34 of the polishing head 1 and the workpiece and allows the infrared light to reflect off the feature region 100 on the surface S1 of the workpiece W. Therefore, the infrared light emitted from the light-emitting portion 28a of the infrared light source 28 passes through the elastic membrane 34, passes through the workpiece W, and is reflected from the feature region 100 formed on the surface S1 of the workpiece W. The infrared light emitted from the infrared light source 28 is adjusted to have the wavelength that allows the infrared light to reflect off the feature region 100, depending on material, a film thickness, etc., of the feature region 100. In one embodiment, a layer of the workpiece W that transmits the infrared light is made of silicon.

During polishing of the workpiece W, the polishing liquid L is present between the workpiece W and the polishing pad 2. In one embodiment, the infrared light emitted from the infrared light source 28 has a wavelength absorbed by the polishing liquid L present between the workpiece W and the polishing pad 2. The infrared imaging device 27 generates the image of the feature region 100 on the surface S1 of the workpiece W by receiving, with the light-receiving portion 27a, the infrared light that has been reflected from the feature region 100 on the surface S1 of the workpiece W and has passed through the elastic membrane 34. When the film thickness or the material differs between the feature region 100 and other region(s) of the workpiece W, an intensity of the infrared light reflected from the feature region 100 may differ from that reflected at the other region(s). This difference in intensity of the reflected infrared light appears as a color difference (i.e., shading) in the image generated by the infrared imaging device 27. Therefore, the feature region 100 and the other region(s) differing in intensity of the reflected infrared light can be distinguished by the color difference (i.e., shading) in the image.

In this embodiment, the infrared imaging device 27 and the infrared light source 28 are arranged obliquely with respect to the front surface S1 and the back surface S2 of the workpiece W. However, the arrangements of the infrared imaging device 27 and the infrared light source 28 are not particularly limited as long as the infrared imaging device 27 can generate the image of the feature region 100 on the front surface S1 of the workpiece W. In one embodiment, the infrared imaging device 27 and the infrared light source 28 may be perpendicular to the front surface S1 and the back surface S2 of the workpiece W.

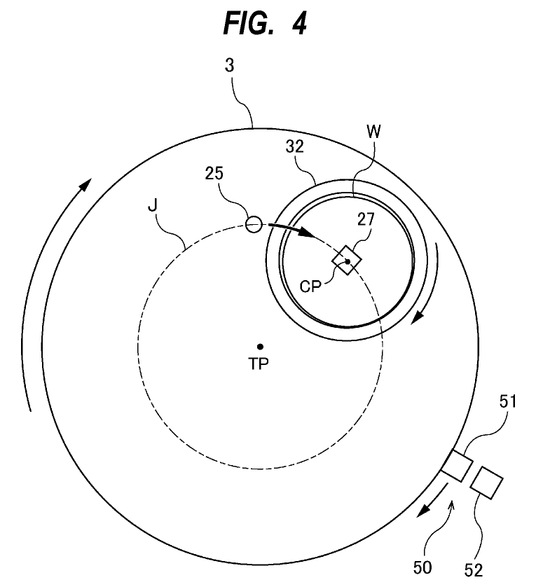

FIG. 4 is a top view showing a positional relationship between the polishing table 3 and the workpiece W held by the polishing head 1. In FIG. 4, depiction of the polishing pad 2, the carrier 31 of the polishing head 1, and the elastic membrane 34 is omitted. The workpiece W is rotated by the polishing head 1. The workpiece W may rotate in the retainer ring 32 relative to the polishing head 1. Therefore, a rotation speed of the workpiece W may not be the same as a rotation speed of the polishing head 1. In the example shown in FIG. 4, the workpiece W rotates in the retainer ring 32 about the center point CP of the workpiece W, as indicated by an arrow.

The film-thickness sensor 25 moves in a path J shown in FIG. 4 as the polishing table 3 rotates. In the embodiment shown in FIG. 4, a radial distance of the film-thickness sensor 25 from the center TP of the polishing table 3 is equal to a radial distance from the center TP of the polishing table 3 to the center of the retainer ring 32 (i.e., the center of the polishing head 1). Therefore, the film-thickness sensor 25 traverses the center point CP of the workpiece W every time the polishing table 3 makes one revolution. When the film-thickness sensor 25 is located below the workpiece W, the processing controller 9 instructs the film-thickness sensor 25 to measure a film thickness at a predetermined measurement point on the surface S1 of the workpiece W.

The polishing apparatus includes a table-angle detector 50 configured to detect a rotation angle of the polishing table 3. In the embodiment shown in FIG. 4, the table-angle detector 50 includes a sensor target 52 disposed adjacent to the polishing table 3 and a proximity sensor 51 fixed to the polishing table 3 and configured to detect the sensor target 52. The sensor target 52 is fixed to a not-shown fixing member, and a position of the sensor target 52 is fixed. The proximity sensor 51 rotates together with the polishing table 3. The proximity sensor 51 detects the sensor target 52 every time the polishing table 3 makes one revolution.

Since the sensor target 52 is stationary, the rotation angle of the polishing table 3 at a point in time when the proximity sensor 51 detects the sensor target 52 is uniquely determined. Therefore, the table-angle detector 50 including the combination of the proximity sensor 51 and the sensor target 52 can detect the rotation angle of the polishing table 3. The table-angle detector 50 is configured to transmit an angle detection signal to the processing controller 9 when the proximity sensor 51 detects the sensor target 52.

The processing controller 9 can determine other rotation angles of the polishing table 3 based on the rotation speed of the polishing table 3 and points in time when the proximity sensor 51 detects the sensor target 52. For example, a rotation angle of the polishing table 3 at a point in time after a predetermined time has elapsed since the proximity sensor 51 has detected the sensor target 52 can be calculated from the rotation angle of the polishing table 3 at the point in time the proximity sensor 51 has detected the sensor target 52, the rotation speed of the polishing table 3, and the predetermined time.

In one embodiment, the sensor target 52 may be fixed to the polishing table 3, and the proximity sensor 51 may be fixed to the above-described fixing member (not shown). In this case, the sensor target 52 rotates together with the polishing table 3, and the proximity sensor 51 is stationary. In another embodiment, the table-angle detector 50 that detects the rotation angle of the polishing table 3 may be a rotary encoder incorporated in or coupled to the table motor 6.

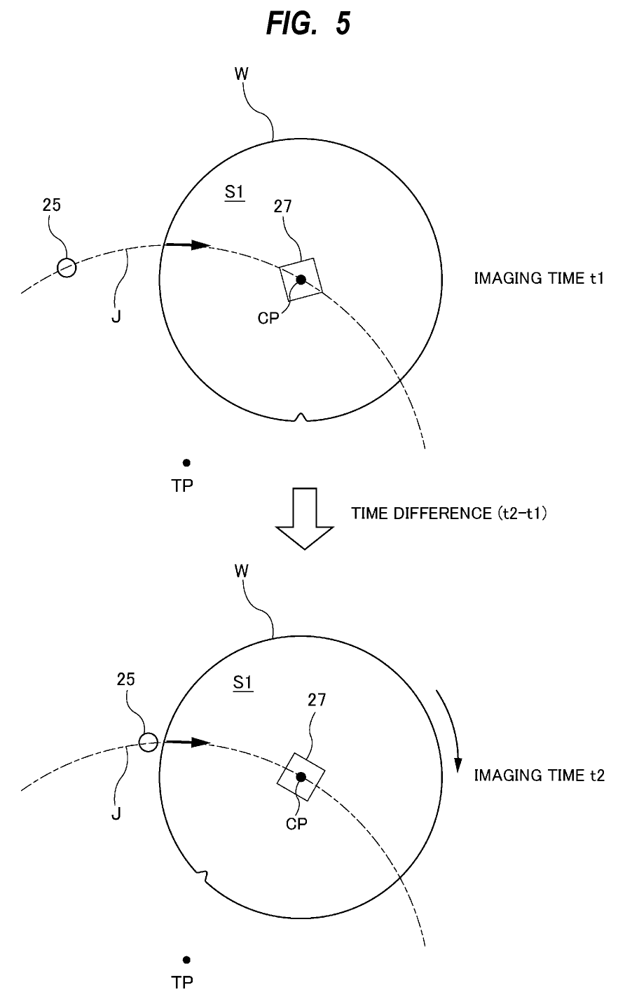

FIG. 5 is a schematic diagram showing an example of generating a first image and a second image by the infrared imaging device 27. As shown in FIG. 5, during polishing of the workpiece W, the infrared imaging device 27 is configured to generate the first image and the second image of the feature region 100 on the surface S1 of the workpiece W at a predetermined time interval. More specifically, during polishing of the workpiece W, the processing controller 9 instructs the infrared imaging device 27 to generate the first image of the feature region 100 on the surface S1 of the workpiece W at an imaging time t1, and then instructs the infrared imaging device 27 to generate the second image of the feature region 100 on the surface S1 of the workpiece W at an imaging time t2.

The infrared imaging device 27 is fixed to the polishing head 1, so that the infrared imaging device 27 rotates together with the polishing head 1. In this embodiment, the infrared imaging device 27 is arranged at the center of the polishing head 1. Therefore, the infrared imaging device 27 generates an image of an area including the center point CP of the workpiece W. A time difference t2-t1 between the imaging time t1 when the first image is generated and the imaging time t2 when the second image is generated corresponds to the predetermined time interval. The first image and the second image are transmitted from the infrared imaging device 27 to the processing controller 9.

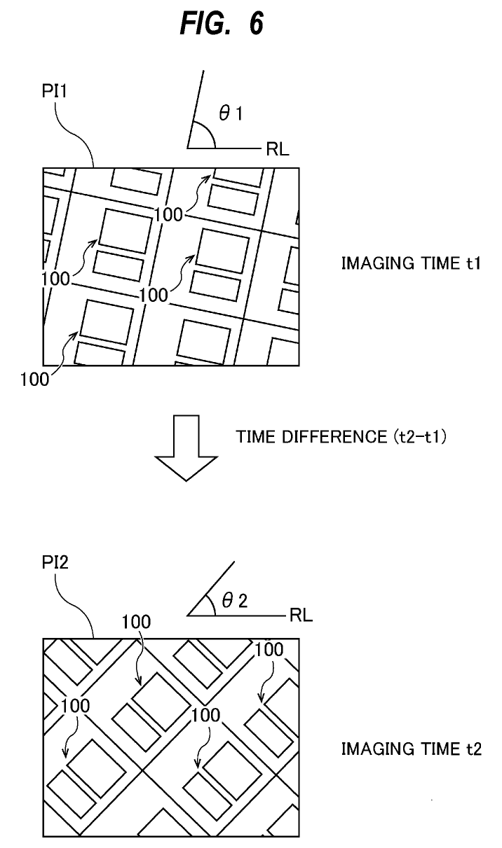

FIG. 6 is a schematic diagram showing an example of the first image PI1 and the second image PI2 generated by the infrared imaging device 27. In the example shown in FIG. 6, the feature region 100 is a pattern, such as interconnect pattern, cell, scribal line, or dicing line. As shown in FIG. 6, the first image PI1 and the second image PI2 include the feature region(s) 100 on the surface S1 of the workpiece W. When the workpiece W is rotating relative to the polishing head 1, an angle of inclination of the feature region 100 on the first image PI1 differs from an angle of inclination of the feature region 100 on the second image PI2. The processing controller 9 calculates an angle of inclination θ1 of the feature region 100 on the first image PI1 relative to a reference line RL and an angle of inclinationθ2 of the feature region 100 on the second image PI2 relative to the reference line RL. The reference line RL is not particularly limited. For example, the reference line RL is a straight line extending parallel to one side of the image generated by the infrared imaging device 27.

The processing controller 9 is configured to calculate a rotation angle of the workpiece W per unit time based on the angle of inclination θ1 of the feature region 100 on the first image PI1, the angle of inclination θ2 of the feature region 100 on the second image PI2, and the predetermined time interval (t2-t1). More specifically, the processing controller 9 calculates a difference (θ2-θ1) between the angle of inclination θ1 of the feature region 100 on the first image PI1 and the angle of inclination θ2 of the feature region 100 on the second image PI2. The processing controller 9 calculates a relative rotation angle of the workpiece W with respect to the polishing head 1 per unit time by dividing the difference in angle of inclination (θ2-θ1) by the time interval (t2-t1). When the rotation speed of the workpiece W is the same as the rotation speed of the polishing head 1, the angle of inclination of the feature region 100 on the first image PI1 is the same as the angle of inclination of the feature region 100 on the second image PI2. Therefore, the relative rotation angle of the workpiece W with respect to the polishing head 1 per unit time is zero.

The processing controller 9 calculates the rotation angle of the workpiece W per unit time by subtracting the relative rotation angle of the workpiece W with respect to the polishing head 1 per unit time from a rotation angle of the polishing head 1 in the time interval (t2-t1) detected by the head-angle detector 22. In this embodiment, the two images PI1 and PI2 are used to calculate the rotation angle of the workpiece W per unit time. However, in another embodiment, three or more images may be used to calculate the rotation angle of the workpiece W per unit time.

The film-thickness sensor 25 measures a film thickness at a predetermined measurement point on the surface S1 of the workpiece W at a measuring time t3, after the infrared imaging device 27 has generated the first image PI1 and the second image PI2. The imaging time t1 when the infrared imaging device 27 generates the first image PI1, the imaging time t2 when the infrared imaging device 27 generates the second image PI2, and the measuring time t3 when the film-thickness sensor 25 measures the film thickness at the predetermined measurement point are all contained in a time period during which the polishing table 3 makes one rotation. Specifically, while the polishing table 3 makes one rotation, the infrared imaging device 27 generates the first image and the second image, and the film-thickness sensor 25 measures the film thickness at the predetermined measurement point.

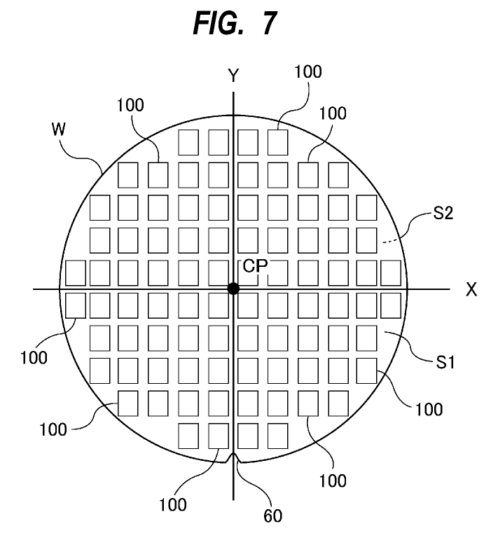

A position of the predetermined measurement point on the surface S1 of the workpiece W is specified by coordinates on a coordinate system shown in FIG. 7. FIG. 7 is a schematic diagram showing an example of the coordinate system defined on the surface S1 of the workpiece W. The workpiece W has a notch (or cut) 60 in an edge portion of the workpiece W. In this example, Y-axis of the coordinate system extends through the notch 60 and the center point CP of the workpiece W, and X-axis extends through the center point CP of the workpiece W and is perpendicular to the Y-axis. This coordinate system is an orthogonal coordinate system. In the following descriptions, the coordinate system defined on the surface S1 of the workpiece W may be referred to as an X-Y coordinate system.

As shown in FIG. 7, patterns as multiple feature regions 100 are formed in the surface S1 of the workpiece W. These patterns are aligned along the Y-axis and the X-axis of the X-Y coordinate system. Specifically, alignment directions of the multiple patterns are parallel to the Y-axis and the X-axis of the X-Y coordinate system.

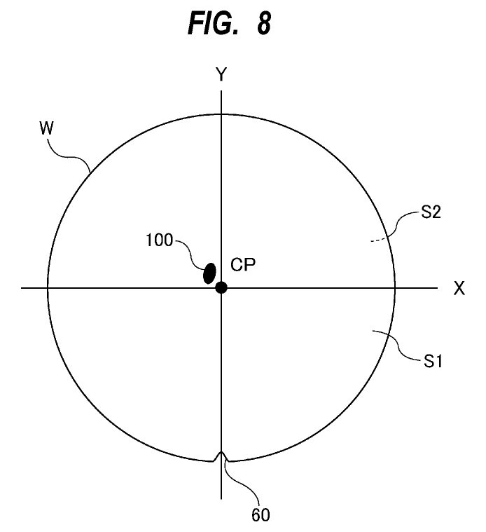

FIG. 8 is a schematic diagram showing another example of the feature region 100. In the example shown in FIG. 8, the workpiece W is a blanket wafer having a film. The feature region 100 is a region distinguishable from other region(s) by a difference in film thickness. In one example, the feature region 100 is a region having a film thickness larger than that of the other region(s) of the workpiece W. In another example, the feature region 100 may be a region having a film thickness smaller than that of the other region(s) of the workpiece W. In this embodiment, the feature region 100 is located near the center of the workpiece W, and is located below the infrared imaging device 27 and the infrared light source 28.

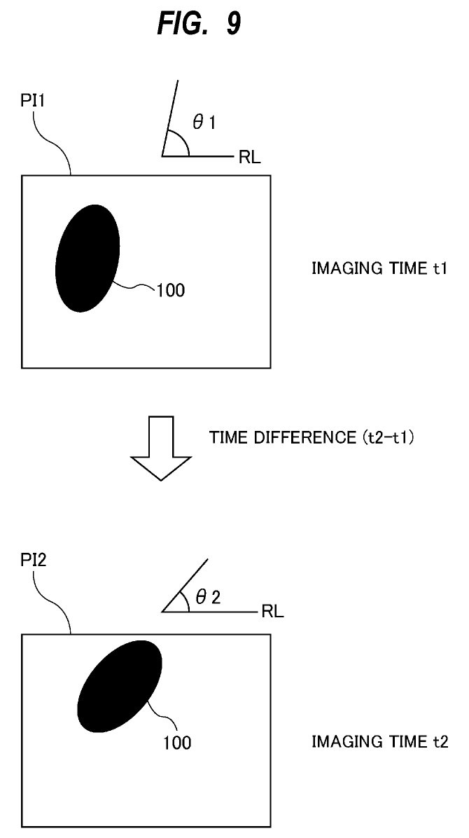

FIG. 9 is a schematic diagram showing an example of the first image PI1 and the second image PI2 including the feature region 100 shown in FIG. 8. As shown in FIG. 9, the first image PI1 and the second image PI2 include the feature region 100 on the front surface S1 of the workpiece W. In other words, the feature region 100 is located in the imaging area of the infrared imaging device 27 at least in the imaging time t1 and the imaging time t2.

In the example shown in FIG. 9, as with the example described with reference to FIG. 6, the processing controller 9 calculates an angle of inclination θ1 of the feature region 100 on the first image PI1 relative to a reference line RL and an angle of inclination θ2 of the feature region 100 on the second image PI2 relative to the reference line RL. The reference line RL is not particularly limited. For example, the reference line RL is a straight line extending parallel to one side of the image generated by the infrared imaging device 27. The processing controller 9 calculates a rotation angle of the workpiece W per unit time based on the angle of inclination θ1 of the feature region 100 on the first image PI1, the angle of inclination θ2 of the feature region 100 on the second image PI2, and the predetermined time interval (t2-t1).

As long as the processing controller 9 can calculate the angle of inclination θ1 of the feature region 100 on the first image PI1 and the angle of inclination θ2 of the feature region 100 on the second image PI2, the shape of the feature region 100 may change as the workpiece W is polished.

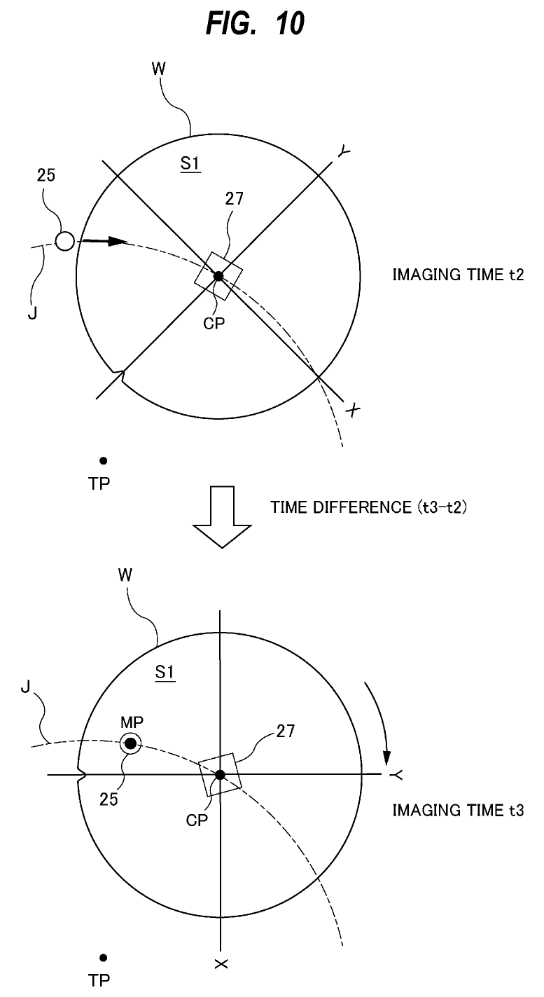

FIG. 10 is a schematic diagram showing an example of generating the images by the infrared imaging device 27 and measuring a film thickness by the film-thickness sensor 25. As described above, the processing controller 9 instructs the infrared imaging device 27 to generate the second image PI2 of the feature region 100 on the surface S1 of the workpiece W at the imaging time t2. The processing controller 9 determines an angle of inclination of the X-Y coordinate system defined on the surface S1 of the workpiece W based on the angle of inclination of the feature region 100 in the second image PI2 (e.g., angle θ2 in FIG. 6 or FIG. 9). The angle of inclination of the X-Y coordinate system at the imaging time t2 coincides with the angle of inclination of the feature region 100 in the second image PI2.

During polishing of the workpiece W, the processing controller 9 instructs the film-thickness sensor 25 to measure the film thickness at a predetermined measurement point MP on the surface S1 of the workpiece W when the film-thickness sensor 25 is located below the workpiece W (i.e., the measuring time t3). The measuring time t3 when the film-thickness sensor 25 measures the film thickness at the measurement point MP on the surface S1 of the workpiece W is a point in time after the imaging time t2 at which the infrared imaging device 27 generates the second image PI2. Although the coordinates of the measurement point MP in the coordinate system described with reference to FIG. 7 are unknown at this point, the relative position of the measurement point MP with respect to the center point CP of the workpiece W can be determined from the radial distance between the film-thickness sensor 25 and the center TP of the polishing table 3, and the rotation angle of the polishing table 3 at the measuring time t3. During polishing of the workpiece W, a position of the center point CP of the workpiece W relative to the polishing table 3 is fixed. On the other hand, the film-thickness sensor 25 moves relative to the center point CP of the workpiece W. The path J of the film-thickness sensor 25 traversing the surface S1 of the workpiece W is determined from the radial distance between the film-thickness sensor 25 and the center TP of the polishing table 3. The processing controller 9 can uniquely determine the relative position of the film-thickness sensor 25 with respect to the center point CP of the workpiece W based on the radial distance between the film-thickness sensor 25 and the center TP of the polishing table 3, and the rotation angle of the polishing table 3.

In an example, the processing controller 9 calculates the measuring time t3, which is a point in time after a predetermined delay time has elapsed since the point in time when the processing controller 9 receives an angle detection signal transmitted from the table-angle detector 50 including the proximity sensor 51 and the sensor target 52. The processing controller 9 instructs the film-thickness sensor 25 to measure the film thickness at the measurement point MP on the surface S1 of the workpiece W at the measuring time t3. The predetermined delay time is determined based on a difference between the position of the film-thickness sensor 25 and the position of the measurement point MP on the workpiece W at the point in time when the processing controller 9 receives the angle detection signal, and the rotation speed of the polishing table 3.

In another example, the processing controller 9 receives the rotation angle of the polishing table 3 transmitted from the table-angle detector 50 constituted of the rotary encoder. The processing controller 9 instructs the film-thickness sensor 25 to measure the film thickness at the measurement point MP on the surface S1 of the workpiece W at the measuring time t3, which is a point in time the rotation angle of the polishing table 3 reaches a predetermined measurement angle. In this manner, the relative position of the measurement point MP with respect to the center point CP of the workpiece W can be determined from the radial distance between the film-thickness sensor 25 and the center TP of the polishing table 3, and the rotation angle of the polishing table 3 at the measuring time t3.

As shown in FIG. 10, the position of the film-thickness sensor 25 at the imaging time t2 is located away from the measurement point MP on the surface S1 of the workpiece W in a circumferential direction of the polishing table 3. Therefore, there is a time difference t3-t2 between the measuring time t3 when the film-thickness sensor 25 measures the film thickness at the measurement point MP and the imaging time t2 when the imaging device 24 generates the second image PI2 of the workpiece W (see FIGS. 6 and 9). During this time difference t3-t2, the workpiece W rotates about its center point CP. The rotation speed of the workpiece W at this time is represented by the rotation angle of the workpiece W per unit time described above.

The processing controller 9 determines the coordinates of the measurement point MP on the surface S1 of the workpiece W as follows. The processing controller 9 calculates the time difference t3-t2 between the measuring time t3 when the film thickness at the measurement point MP is measured, and the imaging time t2 when the second image PI2 is generated. The processing controller 9 determines the coordinates of the measurement point MP on the surface S1 of the workpiece W based on the relative position between the measurement point MP and the center point CP of the workpiece W, the rotation angle of the workpiece W per unit time, and the time difference t3-t2.

During the time difference t3-t2, the workpiece W rotates about its center point CP. Therefore, the X-Y coordinate system defined on the surface S1 of the workpiece W also rotates about the center point CP of the workpiece W during the time difference t3-t2. The processing controller 9 calculates the rotation angle of the X-Y coordinate system rotating during the time difference t3-t2 by multiplying the rotation angle of the workpiece W per unit time by the time difference t3-t2. Furthermore, as shown in FIG. 10, the processing controller 9 determines the X-Y coordinate system at the measuring time t3 by rotating the X-Y coordinate system at the imaging time t2 by the calculated rotation angle about the center point CP of the workpiece W. The actual position of the measurement point MP on the surface S1 of the workpiece W is specified by the coordinates of the measurement point MP in the X-Y coordinate system at the measuring time t3.

In this manner, the processing controller 9 can determine the coordinates of the measurement point MP (i.e., the actual position of the measurement point MP) reflecting the free rotation of the workpiece W in the retainer ring 32. These coordinates of the measurement point MP specify not only the position in the radial direction of the workpiece W but also the position in the circumferential direction of the workpiece W. Therefore, the film thickness profile of the workpiece W can be obtained not only in the radial direction but also in the circumferential direction.

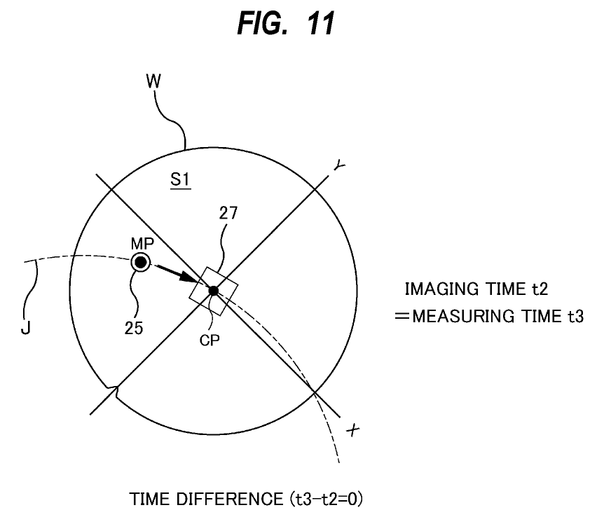

FIG. 11 is a schematic diagram showing another example of generating the image by the infrared imaging device 27 and measuring the film thickness by the film-thickness sensor 25. In this embodiment, the position of the film-thickness sensor 25 at the imaging time t2 coincides with the measurement point MP on the surface S1 of the workpiece W. In other words, measuring of the film thickness at the measurement point MP by the film-thickness sensor 25 and generating of the second image PI by the infrared imaging device 27 are performed at the same time. Therefore, the time difference t3-t2 is zero. In this example, the workpiece W does not rotate relative to the polishing head 1 between the imaging time t2 and the measuring time t3. Therefore, the angle of inclination of the X-Y coordinate system at the measuring time t3 is the same as the angle of inclination of the X-Y coordinate system at the imaging time t2. The coordinates of the measurement point MP are the coordinates on the X-Y coordinate system at the imaging time t2 (i.e., the measuring time t3).

The rotation speed of the workpiece W, which rotates freely in the retainer ring 32, is substantially constant, while the rotation speed of the workpiece W may slightly vary. Therefore, it is preferable that the time differencet3-t2 between the measuring time t3 when the film thickness at the measurement point MP is measured and the imaging time t2 when the second image PI2 is generated be as short as possible. According to the embodiment shown in FIG. 11, the time difference t3-t2 is zero, so that the coordinates of the measurement point MP can be determined accurately.

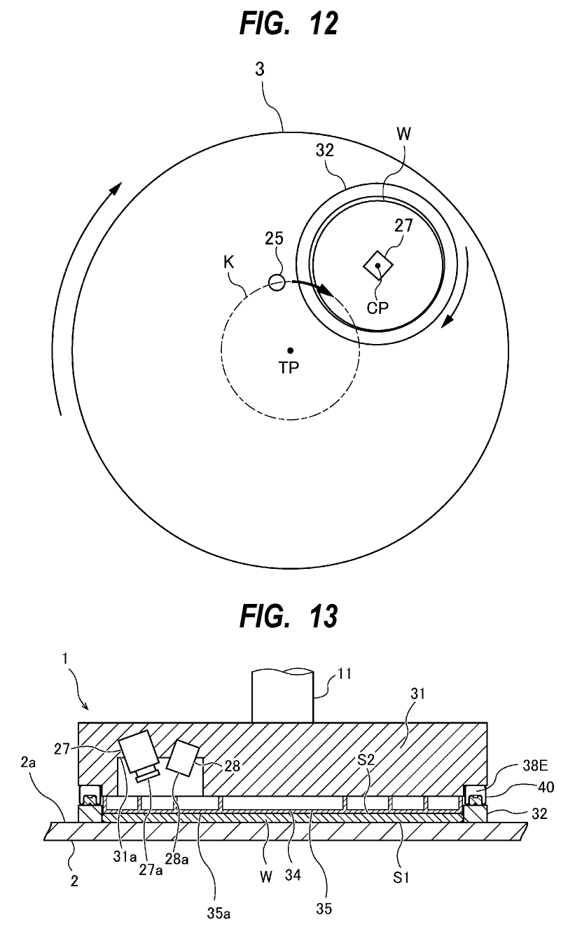

FIG. 12 is a top view showing another embodiment of the film-thickness sensor 25. In this embodiment, the film-thickness sensor 25 is arranged so as to pass through the edge portion of the workpiece W. Specifically, the radial distance of the film-thickness sensor 25 from the center TP of the polishing table 3 is shorter than a distance from the center TP of the polishing table 3 to the infrared imaging device 27 and the center point CP of the workpiece W. The film-thickness sensor 25 moves in a path K shown in FIG. 12, and measures the film thickness at a measurement point on the edge portion while traversing the edge portion of the workpiece W. In this embodiment, as with the embodiments described with reference to FIGS. 1 to 11, the processing controller 9 can determine the coordinates of the measurement point on the edge portion of the workpiece W.

In the embodiments shown in FIGS. 1 to 12, the infrared imaging device 27 is arranged at the center of the polishing head 1, while the position of the infrared imaging device 27 in the polishing head 1 is not particularly limited. FIG. 13 is a cross-sectional view of the polishing head 1 provided with another embodiment of the infrared imaging device 27 and the infrared light source 28. As shown in FIG. 13, the infrared imaging device 27 may be arranged at an outer portion of the polishing head 1. The infrared light source 28 is arranged adjacent to the infrared imaging device 27. The recess 31a, in which the light-receiving portion 27a of the infrared imaging device 27 and the light-emitting portion 28a of the infrared light source 28 are arranged, is located at the outer portion of the polishing head 1. The recess 31a is open in a bottom of the carrier 31.

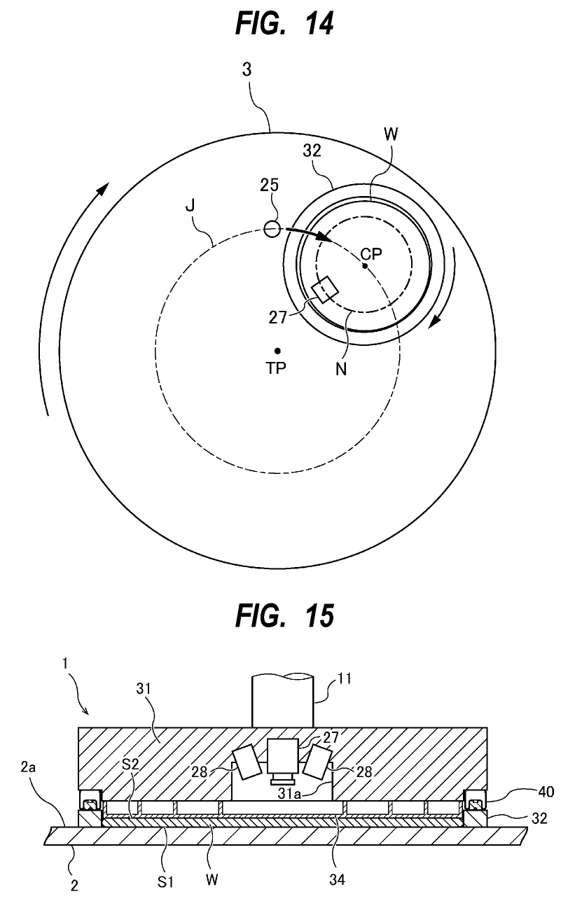

FIG. 14 is a top view showing a positional relationship between the polishing table 3 and the workpiece W held by the polishing head 1 according to the embodiment shown in FIG. 13. Since the infrared imaging device 27 is fixed to the polishing head 1, the infrared imaging device 27 moves in a path N shown in FIG. 14 as the polishing head 1 rotates. Therefore, the infrared imaging device 27 generates an image of the edge portion of the workpiece W. In this embodiment, as with the embodiments described with reference to FIGS. 1 to 11, the processing controller 9 calculates the rotation angle of the workpiece W per unit time based on the angle of inclination θ1 of the feature region 100 in the first image PI1, the angle of inclination θ2 of the feature region 100 in the second image PI2, and the predetermined time interval (t2-t1). The processing controller 9 can determine the coordinates of the measurement point on the surface S1 of the workpiece W based on the calculated rotation angle of the workpiece W per unit time.

FIG. 15 is a cross-sectional view of the polishing head 1 provided with still another embodiment of the infrared imaging device 27 and the infrared light source 28. As shown in FIG. 15, the polishing apparatus may include multiple (in this embodiment, two) infrared light sources 28. In this embodiment, the infrared imaging device 27 is arranged perpendicular to the front surface S1 and the back surface S2 of the workpiece W, and the multiple infrared light sources 28 are arranged adjacent to both sides of the infrared imaging device 27. The multiple infrared light sources 28 can irradiate the feature region 100 on the surface S1 of the workpiece W with the infrared light at a high intensity. Therefore, an intensity of the infrared light reflected from the feature region 100 on the surface S1 of the workpiece W also increases. As a result, the infrared imaging device 27 can generate a clear image of the feature region 100 on the surface S1 of the workpiece W.

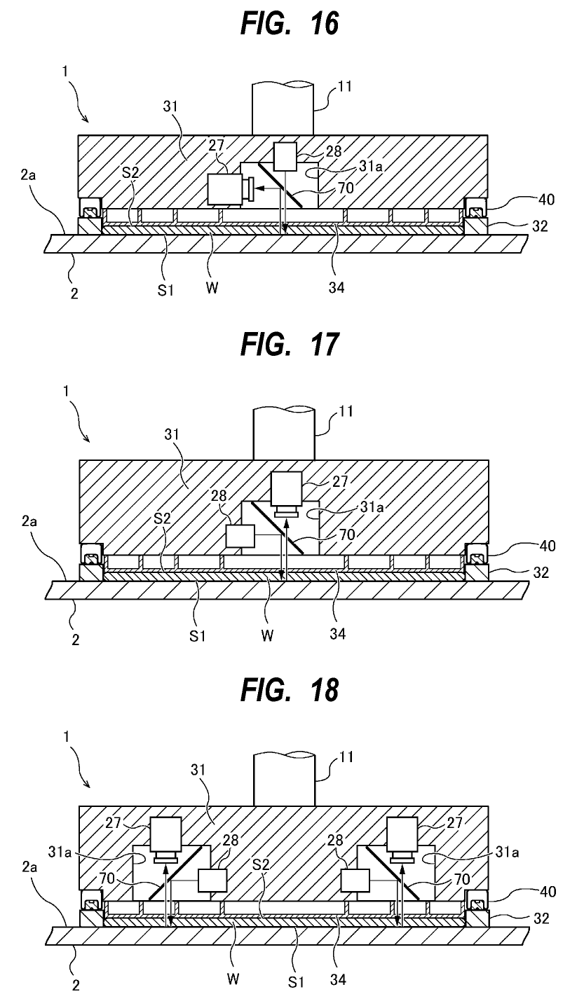

FIG. 16 is a cross-sectional view of the polishing head 1 according to still another embodiment of the infrared imaging device 27 and the infrared light source 28. As shown in FIG. 16, the polishing apparatus may further include a half-mirror 70 arranged in the polishing head 1. The half-mirror 70 is configured to allow the infrared light emitted from the infrared light source 28 to pass therethrough and reflect the infrared light reflected from the feature region 100 on the surface S1 of the workpiece W. The half-mirror 70 is arranged in the recess 31a and is fixed to the carrier 31 of the polishing head 1. In this embodiment, the infrared imaging device 27 is arranged laterally of a side of the half-mirror 70, and is arranged parallel to the surface S1 and the back surface S2 of the workpiece W. The infrared light source 28 is arranged above the half-mirror 70, and is arranged perpendicular to the surface S1 and the back surface S2 of the workpiece W.

The half-mirror 70 is obliquely arranged on an optical path of the infrared light emitted from the infrared light source 28 and an optical path of the infrared light reflected from the feature region 100. The infrared imaging device 27 generates the image of the feature region 100 on the surface S1 of the workpiece W by receiving the infrared light that is emitted from the infrared light source 28, passes through the half-mirror 70, is reflected from the feature region 100 on the surface S1 of the workpiece W, and is reflected from the half-mirror 70.

FIG. 17 is a cross-sectional view of the polishing head 1 provided with still another embodiment of the infrared imaging device 27 and the infrared light source 28. In this embodiment, the half-mirror 70 is configured to reflect the infrared light emitted from the infrared light source 28 and allow the infrared light reflected from the feature region 100 on the surface S1 of the workpiece W to pass therethrough. In this embodiment, the infrared imaging device 27 is arranged above the half-mirror 70, and is arranged perpendicular to the surface S1 and the back surface S2 of the workpiece W. The infrared light source 28 is arranged laterally of the side of the half-mirror 70, and is arranged parallel to the surface S1 and the back surface S2 of the workpiece W.

The half-mirror 70 is obliquely arranged on an optical path of the infrared light emitted from the infrared light source 28 and an optical path of the infrared light reflected from the feature region 100. The infrared imaging device 27 generates the image of the feature region 100 on the surface S1 of the workpiece W by receiving the infrared light that is emitted from the infrared light source 28, is reflected from the half-mirror 70, is reflected from the feature region 100 on the surface S1 of the workpiece W, and passes through the half-mirror 70.

FIG. 18 is a cross-sectional view of the polishing head 1 provided with still another embodiment of the infrared imaging device 27 and the infrared light source 28. As shown in FIG. 18, the polishing apparatus may include multiple (in this embodiment, two) infrared imaging devices 27, multiple (in this embodiment, two) infrared light sources 28, and multiple (in this embodiment, two) half-mirrors 70. In this embodiment, the polishing apparatus includes two sets of configurations each including a combination of the infrared imaging device 27, the infrared light source 28, and the half-mirror 70 described with reference to FIG. 17.

The two sets of configurations each including the combination of the infrared imaging device 27, the infrared light source 28, and the half-mirror 70 are arranged at the outer portion of the polishing head 1. The carrier 31 has two recesses 31a located in the outer portion of the polishing head 1. The infrared imaging device 27, the infrared light source 28, and the half-mirror 70 arranged in each recess 31a. Thus, using the multiple infrared imaging devices 27 can increase the number of images generated while the polishing table 3 makes one revolution.

When film thicknesses at multiple measurement points on the surface S1 of the workpiece W are measured by the film-thickness sensor 25 while the polishing table 3 makes one revolution, it is necessary to generate multiple first images and multiple second images corresponding to the multiple measurement points in order to calculate the rotation angle of the workpiece W per unit time for use in determining coordinates of each measurement point. Therefore, according to the embodiment shown in FIG. 18, even when the number of measurement points is large, many images can be generated while the polishing table 3 makes one revolution. As a result, the rotation angle of the workpiece W per unit time for use in determining the coordinates of each measurement point can be calculated.

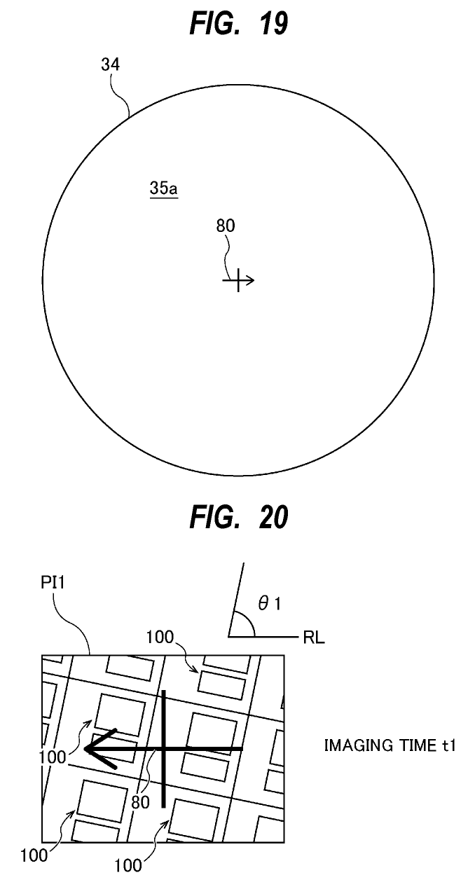

In one embodiment, the elastic membrane 34 of the polishing head 1 may have a mark for specifying an orientation in a circumferential direction of the elastic membrane 34. FIG. 19 is a schematic diagram showing an embodiment of the elastic membrane 34 having a mark 80. The mark 80 is printed with ink on the contact surface 35a of the elastic membrane 34. As shown in FIG. 19, the mark 80 of this embodiment is a figure or graphic including a combination of a cross and an arrow. The mark 80 is located below the recess 31a of the carrier 31, and is located on the optical path of the infrared light emitted from the infrared light source 28. The ink used for the mark 80 is made of a material that reflects the infrared light emitted from the infrared light source 28. Therefore, the infrared imaging device 27 is configured to generate an image of the mark 80 by receiving the infrared light reflected from the mark 80.

In other embodiments, the mark 80 may be formed by an embossing process on the contact surface 35a of the elastic membrane 34. A thickness of the elastic membrane 34 in a portion where the embossed mark 80 is located is larger than a thickness in other portion, so that the infrared light emitted from the infrared light source 28 does not completely pass the portion where the embossed mark 80 is located, and part of the infrared light is reflected from that portion. The infrared imaging device 27 generates the image of the mark 80 by receiving the part of the reflected infrared light from the mark 80. The shape of the mark 80 is not particularly limited to this embodiment, and may be circular, rectangular, lattice-shaped, or may be a character string.

FIG. 20 is a schematic diagram showing an example of the first image PI1 generated by the infrared imaging device 27 disposed in the polishing head 1 having the elastic membrane 34 shown in FIG. 19. As shown in FIG. 20, the first image PI1 includes the feature region(s) 100 on the surface S1 of the workpiece W and the mark 80 of the elastic membrane 34. In FIG. 20, an example of the feature region 100 as a pattern formed on the surface S1 of the workpiece W is described, while the feature region 100 may be a region distinguishable from other region(s) due to a difference in film thickness film thickness, material, etc., as described with reference to FIGS. 8 and 9.

In this embodiment, the processing controller 9 uses the mark 80 on the first image PI1 as the above-described reference line RL. Specifically, the processing controller 9 calculates the angle of inclination θ1 of the feature region 100 on the first image PI1 based on the mark 80 on the first image PI1. In this embodiment, the processing controller 9 calculates the angle of inclination θ1 of the feature region 100 on the first image PI1 based on the arrow constituting the mark 80 as the reference line RL.

The infrared imaging device 27 is fixed to the polishing head 1, so even when the polishing head 1 rotates, the position of the mark 80 on the image remains fixed. Similarly, for the second image PI2, the processing controller 9 calculates the angle of inclination θ2 of the feature region 100 on the second image PI2 based on the mark 80 on the second image PI2. In this embodiment, as well as the above-described embodiment, the processing controller 9 calculates the rotation angle of the workpiece W per unit time and determines the coordinates of the measurement point MP on the surface S1 of the workpiece W.

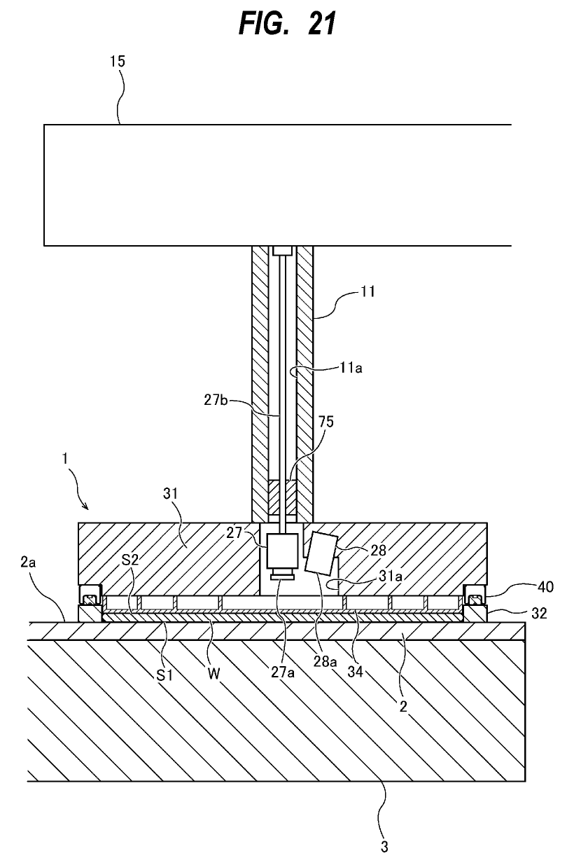

In the embodiments described with reference to FIGS. 1 to 20, the infrared imaging device 27 is fixed to the polishing head 1 and rotates together with the polishing head 1. In one embodiment, the infrared imaging device 27 may not be fixed to the polishing head 1 and may not rotate together with the polishing head 1. FIG. 21 is a cross-sectional view of the polishing head 1 showing an embodiment of the infrared imaging device 27 not fixed to the polishing head 1. In this embodiment, the infrared imaging device 27 is fixed to the head arm 15 as a fixing member. More specifically, a power supply portion 27b of the infrared imaging device 27 is fixed to the head arm 15. However, the fixing member is not particularly limited to the head arm 15 as long as the fixing member does not rotate together with the polishing head 1.

In this embodiment, the polishing-head shaft 11 has a hollow structure, and includes a passage 11a extending through the polishing-head shaft 11 in an axial direction. The power supply portion 27b of the infrared imaging device 27 extends from the head arm 15 through the passage 11a of the polishing-head shaft 11 to the recess 31a in the polishing head 1. In this embodiment, the recess 31a communicates with the passage 11a of the polishing-head shaft 11, and the infrared imaging device 27 is arranged in the polishing head 1 with no contact with the polishing head 1. In one embodiment, as shown in FIG. 21, the polishing apparatus may include a slip ring 75 configured to rotatably support the polishing-head shaft 11, and the power supply portion 27b of the infrared imaging device 27 may be supported by the slip ring 75 in the polishing-head shaft 11. The slip ring 75 is arranged in the passage 11a of the polishing-head shaft 11 and is configured to rotatably support the polishing-head shaft 11 with an outer surface of the slip ring 75. With such a configuration, during rotation of the polishing head 1 and the polishing-head shaft 11, the infrared imaging device 27 does not rotate together with the polishing head 1.

In this embodiment, the rotation angle of the workpiece W per unit time is calculated as follows. The processing controller 9 instructs the infrared imaging device 27 to generate a first image PI1 of a feature region on the surface S1 of the workpiece W at an imaging time t1, and then to generate a second image PI2 of the feature region on the surface S1 of the workpiece W at an imaging time t2. The processing controller 9 calculates the rotation angle of the workpiece W per unit time based on the angle of inclination θ1 of the feature region in the first image PI1, the angle of inclination θ2 of the feature region in the second image PI2, and the predetermined time interval (t2-t1). More specifically, the processing controller 9 calculates a difference (θ2-θ1) between the angle of inclination θ1 of the feature region on the first image PI1 and the angle of inclination θ2 of the feature region on the second image PI2. The processing controller 9 then calculates the rotation angle of the workpiece W per unit time by dividing the difference in angle of inclination difference (θ2-θ1) by the time interval (t2-t1). In this embodiment, since the infrared imaging device 27 does not rotate together with the polishing head 1, the rotation angle of the workpiece W per unit time can be calculated directly without calculating the relative rotation angle of the workpiece W with respect to the polishing head 1 per unit time.

The film-thickness sensor 25 measures the film thickness at a predetermined measurement point MP on the surface S1 of the workpiece W at a measuring time t3, after the infrared imaging device 27 has generated the first image PI1 and the second image PI2. Determining of the coordinates of the measurement point MP on the surface S1 of the workpiece W by the processing controller 9 is the same as that of the above-described embodiment, and duplicated descriptions will be omitted.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A polishing apparatus comprising:
a polishing table configured to support a polishing pad;
a polishing head configured to press a workpiece against the polishing pad on the polishing table to polish the workpiece, the workpiece having a surface on which a feature region is formed;
a polishing-head motor configured to rotate the polishing head;
a film-thickness sensor fixed to the polishing table and configured to measure a film thickness at a measurement point on the surface of the workpiece;
an infrared imaging device arranged in the polishing head and configured to generate a first image and a second image of the feature region on the surface of the workpiece at a predetermined time interval through a back surface of the workpiece; and
a processing controller configured to determine coordinates of the measurement point on the surface of the workpiece based on the first image and the second image.

2. The polishing apparatus according to claim 1, wherein the processing controller is configured to:
calculate a rotation angle of the workpiece per unit time based on an angle of inclination of the feature region on the first image, an angle of inclination of the feature region on the second image, and the predetermined time interval;
calculate a time difference between a measuring time when the film thickness at the measurement point is measured and an imaging time when the second image is generated; and
determine the coordinates of the measurement point on the surface of the workpiece based on a relative position of the measurement point and a center point of the workpiece, the rotation angle of the workpiece per unit time, and the time difference.

3. The polishing apparatus according to claim 2, wherein the processing controller is configured to:
determine an angle of inclination of a coordinate system predefined on the surface of the workpiece based on the angle of inclination of the feature region on the second image;
calculate a rotation angle of the coordinate system that rotates during the time difference by multiplying the rotation angle of the workpiece per unit time by the time difference;
determine the coordinate system at the measuring time by rotating the coordinate system at the imaging time by the calculated rotation angle about the center point of the workpiece; and
determine the coordinates of the measurement point on the coordinate system at the measuring time from the relative position of the measurement point and the center point of the workpiece.

4. The polishing apparatus according to claim 1, further comprising:
an infrared light source arranged in the polishing head and configured to irradiate the feature region on the surface of the workpiece with infrared light through the back surface of the workpiece,
wherein the infrared light has a wavelength that allows the infrared light to pass through the workpiece and reflect off the feature region, and
the infrared imaging device is configured to generate the first image and the second image by receiving the infrared light that is emitted from the infrared light source and is reflected from the feature region.

5. The polishing apparatus according to claim 4, wherein
the polishing head includes:
an elastic membrane for pressing the workpiece against the polishing pad; and
a carrier to which the elastic membrane is fixed,
the infrared imaging device and the infrared light source are fixed to the carrier, and
the infrared light has a wavelength that allows the infrared light to pass through the elastic membrane and the workpiece and reflect off the feature region.

6. The polishing apparatus according to claim 4, further comprising:
a half-mirror arranged in the polishing head and configured to allow the infrared light emitted from the infrared light source to pass therethrough and reflect the infrared light reflected from the feature region,
wherein the half-mirror is obliquely arranged on an optical path of the infrared light emitted from the infrared light source and an optical path of the infrared light reflected from the feature region, and
the infrared imaging device is configured to generate the first image and the second image by receiving the infrared light that is emitted from the infrared light source, passes through the half-mirror, is reflected from the feature region, and is reflected from the half-mirror.

7. The polishing apparatus according to claim 4, further comprising:
a half-mirror arranged in the polishing head and configured to reflect the infrared light emitted from the infrared light source and allow the infrared light reflected from the feature region to pass therethrough,
wherein the half-mirror is obliquely arranged on an optical path of the infrared light emitted from the infrared light source and an optical path of the infrared light reflected from the feature region, and
the infrared imaging device is configured to generate the first image and the second image by receiving the infrared light that is emitted from the infrared light source, is reflected from the half-mirror, is reflected from the feature region, and passes through the half-mirror.

8. The polishing apparatus according to claim 2, further comprising:
a head-angle detector configured to detect a rotation angle of the polishing head,
wherein the infrared imaging device is fixed to the polishing head,
the processing controller is configured to:
calculate a difference in angle of inclination of the feature region between the first image and the second image;
calculate a relative rotation angle of the workpiece with respect to the polishing head per unit time by dividing the difference in angle of inclination by the predetermined time interval; and
calculate the rotation angle of the workpiece per unit time by subtracting the relative rotation angle of the workpiece with respect to the polishing head per unit time from a rotation angle of the polishing head in the predetermined time interval detected by the head-angle detector.

9. The polishing apparatus according to claim 2, further comprising:
a fixing member configured to fix the infrared imaging device,
wherein the infrared imaging device is not in contact with the polishing head and does not rotate together with the polishing head, and
the processing controller is configured to:
calculate a difference in angle of inclination of the feature region between the first image and the second image; and
calculate the rotation angle of the workpiece per unit time by dividing the difference in angle of inclination by the predetermined time interval.

10. The polishing apparatus according to claim 2, wherein
the polishing head includes:
an elastic membrane for pressing the workpiece against the polishing pad; and
a carrier to which the elastic membrane is fixed,
the elastic membrane has a mark for specifying an orientation in a circumferential direction of the elastic membrane,
the infrared imaging device is fixed to the carrier, and
the processing controller is configured to:
calculate the angle of inclination of the feature region on the first image based on the mark on the first image;
calculate the angle of inclination of the feature region on the second image based on the mark on the second image; and
calculate the rotation angle of the workpiece per unit time based on the predetermined time interval.

11. A polishing method comprising:
polishing a workpiece by pressing the workpiece against a polishing pad on a polishing table with a polishing head while rotating the polishing head, the workpiece having a surface on which a feature region is formed;
during polishing of the workpiece, generating a first image and a second image of the feature region on the surface of the workpiece at a predetermined time interval through a back surface of the workpiece by an infrared imaging device arranged in the polishing head;
during polishing of the workpiece, measuring a film thickness at a measurement point on the surface of the workpiece by a film-thickness sensor fixed to the polishing table; and
determining coordinates of the measurement point on the surface of the workpiece based on the first image and the second image.

12. The polishing method according to claim 11, wherein determining the coordinates of the measurement point comprises:
calculating a rotation angle of the workpiece per unit time based on an angle of inclination of the feature region on the first image, an angle of inclination of the feature region on the second image, and the predetermined time interval;
calculating a time difference between a measuring time when the film thickness at the measurement point is measured and an imaging time when the second image is generated; and
determining the coordinates of the measurement point on the surface of the workpiece based on a relative position of the measurement point and a center point of the workpiece, the rotation angle of the workpiece per unit time, and the time difference.

13. The polishing method according to claim 12, wherein determining the coordinates of the measurement point on the surface of the workpiece based on the relative position of the measurement point and the center point of the workpiece, the rotation angle of the workpiece per unit time, and the time difference comprises:
determining an angle of inclination of a coordinate system predefined on the surface of the workpiece based on the angle of inclination of the feature region on the second image;
calculating a rotation angle of the coordinate system that rotates during the time difference by multiplying the rotation angle of the workpiece per unit time by the time difference;
determining the coordinate system at the measuring time by rotating the coordinate system at the imaging time by the calculated rotation angle about the center point of the workpiece; and
determining the coordinates of the measurement point on the coordinate system at the measuring time from the relative position of the measurement point and the center point of the workpiece.

14. The polishing method according to claim 11, further comprising:
during polishing of the workpiece, irradiating the feature region on the surface of the workpiece with infrared light through the back surface of the workpiece by an infrared light source arranged in the polishing head,
wherein generating the first image and the second image by the infrared imaging device comprises generating the first image and the second image by receiving the infrared light that is emitted from the infrared light source and is reflected from the feature region, and
the infrared light has a wavelength that allows the infrared light to pass through the workpiece and reflect off the feature region.

15. The polishing method according to claim 14, wherein the polishing head includes:
an elastic membrane for pressing the workpiece against the polishing pad; and
a carrier to which the elastic membrane is fixed,
the infrared imaging device and the infrared light source are fixed to the carrier, and
the infrared light has a wavelength that allows the infrared light to pass through the elastic membrane and the workpiece and reflect off the feature region.

16. The polishing method according to claim 14, wherein
generating the first image and the second image by the infrared imaging device comprises generating the first image and the second image by receiving the infrared light with the infrared imaging device, the infrared light being emitted from the infrared light source, passing through a half-mirror arranged in the polishing head, being reflected from the feature region, and being reflected from the half-mirror, and
the half-mirror is obliquely arranged on an optical path of the infrared light emitted from the infrared light source and an optical path of the infrared light reflected from the feature region.

17. The polishing method according to claim 14, wherein
generating the first image and the second image by the infrared imaging device comprises generating the first image and the second image by receiving the infrared light with the infrared imaging device, the infrared light being emitted from the infrared light source, being reflected from a half-mirror arranged in the polishing head, being reflected from the feature region, and passing through the half-mirror, and
the half-mirror is obliquely arranged on an optical path of the infrared light emitted from the infrared light source and an optical path of the infrared light reflected from the feature region.

18. The polishing method according to claim 12, further comprising:
detecting a rotation angle of the polishing head,
wherein the infrared imaging device is fixed to the polishing head, and
calculating the rotation angle of the workpiece per unit time comprises:
calculating a difference in angle of inclination of the feature region between the first image and the second image;
calculating a relative rotation angle of the workpiece with respect to the polishing head per unit time by dividing the difference in angle of inclination by the predetermined time interval; and
calculating the rotation angle of the workpiece per unit time by subtracting the relative rotation angle of the workpiece with respect to the polishing head per unit time from a rotation angle of the polishing head in the predetermined time interval detected by a head-angle detector.

19. The polishing method according to claim 12, wherein
the infrared imaging device is fixed to a fixing member, is not in contact with the polishing head, and does not rotate together with the polishing head, and
calculating the rotation angle of the workpiece per unit time comprises:
calculating a difference in angle of inclination of the feature region between the first image and the second image; and
calculating the rotation angle of the workpiece per unit time by dividing the difference in angle of inclination by the predetermined time interval.

20. The polishing method according to claim 12, wherein the polishing head includes:
an elastic membrane for pressing the workpiece against the polishing pad; and
a carrier to which the elastic membrane is fixed,
the elastic membrane has a mark for specifying an orientation in a circumferential direction of the elastic membrane,
the infrared imaging device is fixed to the carrier, and
calculating the rotation angle of the workpiece per unit time comprises:
calculating the angle of inclination of the feature region on the first image based on the mark on the first image;
calculating the angle of inclination of the feature region on the second image based on the mark on the second image; and
calculating the rotation angle of the workpiece per unit time based on the predetermined time interval.
